(19) United States
(12) Patent Application Publication
(10) Pub. No.: US 2025/0132420 A1
(43) Pub. Date: Apr. 24, 2025

(54) ELECTRIC ENERGY STORAGE DEVICE WITH DUAL THERMAL CONTROL AND ASSOCIATED VEHICLE

(71) Applicant: Dana Canada Corporation, Oakville (CA)

(72) Inventor: Fabrice CHOPARD, Saint-Martin-d'Hères (FR)

(21) Appl. No.: 18/645,262

(22) Filed: Apr. 24, 2024

(30) Foreign Application Priority Data
Oct. 24, 2023 (FR) 2311548

(51) Int. Cl. H01M 10/6569; H01M 10/613; H01M 10/625; H01M 10/6552; H01M 10/6554; H01M 50/249

(52) U.S. Cl. CPC H01M 10/6569; H01M 10/613; H01M 10/625; H01M 10/6552; H01M 10/6554; H01M 50/249

(57) ABSTRACT

The present disclosure relates to a thermally controlled energy storage device for electric vehicles, having high thermal evacuation capabilities.

The device includes:
a plurality of electrical cells
   a first heat exchange device comprising a heat pipe in heat exchange capacity with one side of the cells and a cold source of a second heat exchange device, the cold source comprising at least two cold plates.

The second heat exchange device comprises at least one pulsed heat pipe having:
a first wing extending under a condensation part of the gravity heat pipe and in heat exchange capacity with part of the cell edge
a second wing extending in exchange capacity
with at least one of the cold plates;
   a web connecting the wings.

### CROSS REFERENCE TO RELATED APPLICATION

The present application claims priority to French Patent Application No. 2311548, entitled, “ELECTRIC ENERGY STORAGE DEVICE WITH DUAL THERMAL CONTROL AND ASSOCIATED VEHICLE”, filed Oct. 24, 2023. The entire contents of the above-referenced application is hereby incorporated by reference for all purposes.

### TECHNICAL FIELD

The present disclosure relates to the technical field of thermal control of electrical energy storage devices in chemical form for electric vehicles, in other words electrical accumulators or so-called “power” batteries (as opposed to accessory batteries fitted to combustion engine vehicles and used only to start the combustion engine and power the vehicle's equipment).

### BACKGROUND AND SUMMARY

As is well known, an electric battery is a set of electrical accumulators connected together to create an electrical generator of desired voltage and capacity. These accumulators are often referred to as battery cells. Such a battery, and hence these accumulators or cells, enables electrical energy to be stored in chemical form and returned to the electric motor in the form of direct current, in a controlled manner.

The disadvantages of batteries include:
their high costs,
their autonomy,
their charging time,
the difficulty of controlling the temperature they reach, such as in (ultra) fast charge situations, which can lead to the destruction of the battery or even the vehicle.

The ability to cool or, more generally, thermally control one or more cells is therefore a major objective.

Classically, the battery comprises a plurality of electric cells arranged parallel to one another in a line, each cell having two faces connected by a peripheral edge comprising at least a first side, a second side and a third side. side, with the second and third sides parallel to each other and transverse to the first side.

There are three types of cell: prismatic cells, pouch cells and cylindrical cells.

The invention relates only to “prismatic” cells, and to “prismatic” cells. “pouch” or “pouch”.

A prismatic cell carries electrical terminals on the first side only. In other words, the first side carries the anode terminal and the cathode terminal, spaced apart by a specific distance, while the second and third sides are free of any terminals.

A pouch cell holds the electrical terminals laterally, in the position of use, i.e. the anode and cathode terminals are located only on the second and third sides of the cell, one terminal per side. In other words, if the second side carries the anode terminal, then the third side carries the cathode terminal and vice versa, the first side being free of any terminals.

The present disclosure concerns both prismatic and pocket cells.

Thermally controlled devices are already known, comprising an electric battery and at least one cold plate in capacity. heat exchange with the battery cells.

The cold plate comprises two parallel faces, between which a channel for circulating a heat-transfer fluid by means of a pump winds. The channel comprises a fluid inlet and outlet connected to an external fluid circuit that connects, in a closed loop, the cold plate channel to a heat exchanger with the surrounding air, typically a radiator.

The cold plate is thus placed against the battery from one of its sides (for example via a layer of material). TIM (thermal interface material) to capture heat from the battery and conduct it to the radiator for evacuation from the vehicle.

This device is very simple, and only allows heat to be dissipated from one side of the cold plate. Its thermal regulation capabilities are therefore limited.

The present disclosure offers a much more efficient system that takes advantage of both sides of the cold plate.

In fact, the thermal capacities of this device do not allow it to evacuate all the heat required during battery charging, and there is a strong need to offer a thermally controlled electrical energy storage device with high thermal evacuation capacities.

It is also necessary for this heat dissipation to take place in such a way as to obtain a temperature distribution within the cell that is as homogeneous as possible, and where the difference between the highest and lowest temperature does not exceed ten degrees Celsius, optionally five degrees Celsius, such as three degrees Celsius.

This need must also be satisfied while limiting the overall size and/or weight of the device comprising the electricity storage cells and the thermal management section.

Also proposed is a thermally controlled device for storing electrical energy in chemical form for a vehicle, the device comprising:
a plurality of electrical cells;
a first heat exchange device comprising a bent gravity heat pipe having an evaporation portion in heat exchange capacity with one side of the cells and a condensation portion in heat exchange capacity with a cold source of a second side of the cells
heat exchange device, the cold source comprising at least two cold plates;
the second heat exchange device comprising at least one pulsed heat pipe having:
a first wing extending under the condensation part of the gravity heat pipe and in heat exchange capacity with part of the cell edge;
a second wing extending in heat-exchange capacity with
at least one of the cold plates;
a soul connecting the wings.

More specifically, the thermally controlled device may comprise:
an electric battery having a plurality of electric cells each presenting two faces connected by an edge, where the cell is thinnest and where at least a first side, a second side and a third side are located, the second side and third side being parallel to each other and transverse to the first side, each cell comprising a cathode terminal and an anode terminal located on a single side or on two different sides of the edge, the terminals of adjacent cells being connected to each other to form the battery, the cells being arranged parallel to each other, along a longitudinal direction, face to face,
the thermally controlled device being characterized in that it comprises,
in addition:
a first heat exchange device comprising a gravity heat pipe in heat exchange capacity with at least the second side or the third side of the cells and a cold source of at least one second heat exchange device, in which first heat exchange device:
the gravity heat pipe comprises a body internally integrating a series of juxtaposed channels containing a heat-carrying substance and two transverse volumes into which the channels open. channel ends so that they communicate fluidically with each other via these cross-sectional volumes;
the body of the gravity heat pipe is bent, L-shaped or C-shaped, so that the channels each have at least one curved portion located between two wings, a first wing carrying at least one vaporization portion and a second wing carrying a condensation portion, the condensation portion being located at a higher elevation than the vaporization portion relative to gravity in the position of use;
the gravity heat pipe is arranged so that the first wing carrying the vaporization portion extends laterally opposite the second or third side of the cell slice at a first distance, such as zero, while the second wing of the gravity heat pipe carrying the condensation portion extends laterally above the first side of the cell slice, at a second distance strictly greater than the first distance;
the second heat exchange device comprising:
the cold source which comprises at least a first cold plate and a second cold plate in which a heat transfer fluid circulates between an inlet and an outlet, the first and second cold plates extending parallel to each other, longitudinally, flat and facing the first side of the cells;
at least one pulsed heat pipe comprising a body internally integrating at least one channel closed on itself to form a loop and incorporating a heat-carrying substance, the channel being convoluted and extending between an evaporation portion in thermal contact with at least a portion of the first side of the cell edge, and a second condensation portion in thermal contact with a face of each of the first and second cold plates, the body of the pulsed heat pipe being C-bent to present:
a first wing extending longitudinally between the first side of the cell edge and the condensation part of the gravity heat pipe(s), and comprising the evaporation part in exchange capacity with at least part of the first side of the cell slice,
a second wing parallel to the first wing and comprising the condensation portion extending in heat exchange capacity with at least one of the first and second cold plates;
a web connecting the first and second wings.

According to other embodiments:
the second wing of said at least one pulsed heat pipe may extend between two of said at least two cold plates and be capable of with two of said at least two cold plates;
the device may comprise at least a first pulsed heat pipe and at least a second pulsed heat pipe and wherein:
the first wing of the first pulsed heat pipe extends longitudinally between the first side of the cell edge and the condensation part of the gravity heat pipe(s), and in capacity with a first half-length of the first side of the cell slice, and the second wing of the first pulsed heat pipe extends between, and in heat exchange capacity with, the first and second cold plates; and
the first wing of the second pulsed heat pipe extends longitudinally between the first side of the cell edge and the condensation part of the gravity heat pipe(s), and in capacity
with a second half-length on the first side of the cell slice, and the second leg of the second pulsed heat pipe
extends in heat exchange capacity with a free face of the second cold plate;
the device may comprise at least a first pulsed heat pipe and at least a second pulsed heat pipe and wherein:
the first wing of the first pulsed heat pipe extends longitudinally between the first side of the edge of the cells and the condensation part of the gravity heat pipe(s), and it is in
heat exchange capacity with a length of the first cell edge side, and the second wing of the first pulsed heat pipe extends between, and is in heat exchange capacity with, the first and second cold plates; and
the first leg of the second pulsed heat pipe extends longitudinally under the fourth side of the cell slice, and is in heat-exchange capacity with a length of the fourth side of the cell slice, and the second leg of the second pulsed heat pipe is in heat-exchange capacity with a length of the fourth side of the cell slice, and the second leg of the second pulsed heat pipe is in heat-exchange capacity with a length of the fourth side of the cell slice. extends in heat exchange capacity at least with one face of the second cold plate;
the cold source of the second heat exchange device may comprise at least a third cold plate;
the third cold plate can be arranged parallel and in a opposite the second cold plate, in heat exchange capacity with the second wing of the second pulsed heat pipe;
the third cold plate can be arranged against the first cold plate, in heat exchange capacity with said at least one gravity heat pipe, the first and second cold plates being connected to a first heat transfer fluid circuit and the third cold plate being connected to a second heat transfer fluid circuit independent of the first heat transfer fluid circuit;
the cold source of the second heat exchange device may comprise a fourth cold plate arranged parallel and in
with respect to the second cold plate, in heat exchange capacity
with a free face of the second wing of the second pulsed heat pipe;
the pulsed heat pipe(s) may be in thermal contact with the first side and/or the fourth side of the cell or terminals carried by said first side, a layer of electrically insulating material being interposed between the pulsed heat pipe(s) and the first side of the cell or terminals carried by said first side;
cold plates and pulsed heat pipe(s) can be in a single unit block in which the cold plates and the pulsed heat pipe(s) are functionally separated from each other by a single wall;
the device can further comprise a housing in which the plurality of cells are arranged, the housing comprising:
a bottom on which the cells rest and a plurality of gravity heat pipes, and
clamping means configured to clamp each heat pipe against the second side and/or the third side of the opposing cell(s), so that the or each vaporizing portion of the heat pipe(s) is pressed against the opposing cell(s);
the clamping means may comprise upright walls resting against the bottom and surrounding the cells and the plurality of said gravity heat pipes as a whole; and/or
the cold plate covering the second wing of the second pulsed heat pipe can be fixed to the housing so that all the cells and all the gravity and pulsed heat pipes, as a whole, are clamped between the housing and the cold plate covering the second wing of the second pulsed heat pipe.

The present solution also relates to an electric or hybrid vehicle comprising:
at least one electric motor to move it, and
at least one preceding thermally controlled device connected to the motor to supply it with electricity;
at least one electrical outlet connected to said at least one thermally controlled device to charge it with electricity.

Further features of the present disclosure will be set forth in the following detailed description, made with reference to the appended drawings:

### BRIEF DESCRIPTION OF THE FIGURES

FIG. 1 shows a schematic view of an electric vehicle equipped with a thermally controlled device according to the present disclosure.

FIG. 2 shows a schematic perspective view of a gravity heat pipe used in the thermally controlled device according to the present disclosure.

FIG. 3 shows a schematic perspective view, seen from below, of a pulsed heat pipe used in the thermally controlled device according to the present disclosure.

FIG. 4 shows a schematic view of the operating principle of the pulsed heat pipe of FIG. 3 used in the thermally controlled device according to the present disclosure.

FIG. 5 shows a schematic perspective view of the first heat exchange device of a thermally controlled device according to the present disclosure, comprising gravity heat pipes.

FIG. 6 shows a schematic cross-sectional view of the first and second heat exchange devices of a first embodiment of a thermally controlled device according to the present disclosure, comprising a pulsed heat pipe and two cold plates.

FIG. 7 shows a schematic view of the principle in longitudinal section of a second embodiment of a thermally controlled device according to the present disclosure, comprising two pulsed heat pipes and two cold plates.

FIG. 8 shows a schematic view of the principle in longitudinal section of a third embodiment of a thermally controlled device according to the present disclosure, comprising two pulsed heat pipes and three cold plates, the condensation part of each of the pulsed heat pipes being in contact with two of the three cold plates.

FIG. 9 shows a schematic view of principle in longitudinal section of a fourth embodiment of a thermally controlled device according to the present disclosure, comprising a pulsed heat pipe and two cold plates applied against each other, forming a double cold plate between the condensation part of the gravity heat pipe and the condensation part of the pulsed heat pipe.

FIG. 10 shows a schematic view of the principle in longitudinal section a fifth type of thermally controlled device according to the present disclosure, comprising a pulsed heat pipe, two cold plates applied against each other, forming a double cold plate between the condensation part of the gravity heat pipe and the condensation part of the pulsed heat pipe, and an end cold plate covering the other face of the condensation part of the pulsed heat pipe and thus capping the assembly.

FIG. 11 shows a schematic view of the principle in longitudinal section a sixth embodiment of a thermally controlled device according to the present disclosure, comprising two pulsed heat pipes, two cold plates applied against each other, forming a double cold plate between the condensation part of the gravity heat pipe and the condensation part of a first pulsed heat pipe, and an intermediate single cold plate, i.e. in thermal contact with the condensation part of the first pulsed heat pipe on the one hand and the condensation part of the second pulsed heat pipe on the other hand.

FIG. 12 shows a schematic view of the principle in longitudinal section a seventh embodiment of a controlled device according to the present disclosure, similar to the sixth embodiment, but comprising a fourth cold end plate covering the other face of the condensation part of the second pulsed heat pipe and thus capping the assembly.

FIG. 13 shows a schematic view of the principle in longitudinal section an eighth embodiment of a thermally controlled device according to the present disclosure, comprising two pulsed heat pipes and three cold plates, the condensation part of each of the pulsed heat pipes being in contact with two of the three cold plates, the first branch of a first heat pipe with the first side of the cell wafer, and the first leg of a second pulsed heat pipe being able to exchange heat with the fourth side of the cell slice.

FIG. 14 shows a schematic view of the principle in longitudinal section a ninth embodiment of a controlled device according to the present disclosure, similar to the sixth embodiment, but comprising a fourth cold end plate covering the other face of the condensation part of the second pulsed heat pipe and thus capping the assembly, the first branch of a first pulsed heat pipe being in heat exchange capacity with the first side of the cell slice, and the first branch of a second pulsed heat pipe being in heat exchange capacity with the fourth side of the cell slice.

FIG. 15shows a realistic schematic perspective view, partially exploded, in operational position of a tenth embodiment of a thermally controlled device according to the present disclosure, and comprising pocket cells, gravity heat pipes in heat exchange capacity with the second and third sides carrying the electrical terminals, a first pulsed heat pipe, the first branch of which is arranged in heat-exchange capacity with the first side of the cell slice, and a second pulsed heat pipe, the first branch of which is arranged in heat-exchange capacity with the fourth side of the cell slice.

FIG. 16 shows a realistic schematic perspective view, partially exploded, in operational position with clamping means, of a first variant of the seventh embodiment of FIG. 12 of a thermally controlled device according to the present disclosure, comprising frontally two pulsed heat pipes whose condensing part is inserted between the double cold plate and the intermediate cold plate, and dorsally, not visible, two pulsed heat pipes whose condensing part is inserted between the double cold plate and the intermediate cold plate, and dorsally, not visible, two pulsed heat pipes whose condensing part is inserted between the double cold plate and the intermediate cold plate, and dorsally, not visible, two pulsed heat pipes whose condensing part is inserted between the double cold plate and the intermediate cold plate. condensation is inserted between the intermediate cold plate and the end cold plate.

FIG. 17 shows a schematically realistic partial cross-sectional view of the thermally controlled device of FIG. 16.

FIG. 18 shows a realistic schematic partial longitudinal section view of the thermally controlled device of FIG. 16.

FIG. 19 shows a realistic schematic partial longitudinal section view of the thermally controlled device of FIG. 16, in which the stack of cold plates and pulsed heat pipes is made in a block in which the separation between a cold plate channel and a pulsed heat pipe channel is constituted by a single wall.

FIG. 20 shows a realistic schematic exploded perspective view of the all the cold plates and pulsed heat pipes of the seventh method.

FIG. 21 shows a realistic schematic exploded perspective view of the double cold plate of the seventh embodiment.

FIG. 22 shows a realistic schematic cross-sectional view of a heat transfer fluid circuit outlet from the cold plates in contact with the pulsed heat pipes.

FIG. 23 shows a realistic schematic cross-sectional view of a heat transfer fluid circuit outlet from the cold plate in contact with the gravity heat pipes.

FIG. 24 shows a realistic schematic front view, in operational position, of a second variant of the seventh embodiment of a thermally controlled device according to the present disclosure, comprising frontally a pulsed heat pipe whose condensing part is inserted between the double cold plate and the intermediate cold plate, and a pulsed heat pipe whose condensing part is inserted between the intermediate cold plate and the terminal cold plate, and comprising dorsally, partially visible, two heat pipes similar to the first, arranged in opposition.

FIG. 25 shows a schematic view of the principle of a controlled device according to the present disclosure, the cold plates of which are connected to an operational heat transfer fluid circuit.

FIG. 26 shows a schematic view of the temperature gradient obtained within a cell in a thermally controlled device comprising only L-shaped gravity heat pipes.

FIG. 27 shows a schematic view of the temperature gradient obtained within a cell in a thermally controlled device comprising a combination of L-shaped gravity heat pipes and C-shaped pulsed heat pipes.

### DETAILED DESCRIPTION

In this text, the expressions “vertical” and “following the earth's gravity field” are equivalent, and “horizontal” and “following the earth's gravity field” are equivalent. “perpendicular to the Earth's gravity field” are equivalent.

The following description refers to observations made in position (functional) use of the device, in which the walls of the cells extend vertically, and the gravity heat pipes (see definition below) are located laterally and above the cells (possibly also below when the gravity heat pipes are C-shaped). In this position, the first side of the cell edge is horizontal and forms the top of the cells. The fourth side forms the underside, and the second and third sides form the side edges of the cells.

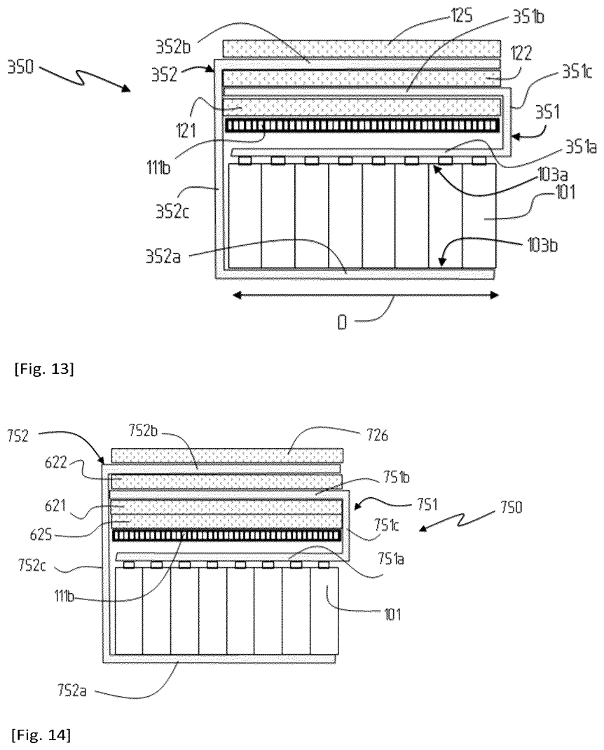

Also in this position, the second heat exchange device comprising the cold plates and pulsed heat pipes (see definition below) is located either above the cells (see FIGS. 6 to 12), or above and below the cells (see FIGS. 13 to 15). The cold plates are arranged horizontally, parallel to all the cells. first sides of the cell slices. The two wings of the C-shaped pulsed heat pipes also extend horizontally and parallel to the cold plates and to all the first sides and/or fourth sides of the cells. sides of the cell wafers. Consequently, the core connecting the two wings of the pulsed heat pipes extends substantially vertically, although it may present a curvature: the portion of the core connected to the first wing comprising the evaporation part is located below the portion of the core connected to the second wing comprising the condensation part, with respect to the direction of gravity.

As a general rule, and as anticipated here, in a heat pipe the vaporization of a liquid in contact with a hot source enables a large quantity of energy to be efficiently absorbed and released to a cold source at a distance from the hot source, thus regulating the temperature of the hot source by maintaining, lowering or limiting the temperature rise, as the case may be).

Heat pipes are, or contain, thermally conductive tubes or channels, often made of metal, used to transport heat using the principle of phase transition transfer. The channels are included in the “body”, which forms the heat pipe. a closed (hermetically sealed) monoblock enclosure around them. Depending on the heat pipes used, they may comprise several channels arranged side by side in parallel, or a single channel closed in on itself and forming convolutions. These two types of channels will be described in more detail later.

The heat pipes comprise a vaporization portion where the heat-carrying substance can be heated, until vaporized, by calories from at least one of the hot sources (in the present application, these are the cells), and a condensation portion where the heat-carrying substance can be cooled, until condensed, by heat exchange. with a cold source (in this case a cold plate).

Unlike cold plates, the heat pipe(s) in question do not require a pumping element (porous body, pump, etc.) to operate. They are therefore closed, watertight devices containing a heat transfer medium, i.e. for the purposes of this presentation, a phase-change fluid, in liquid phase at the condensation temperature relevant to the field in question, in equilibrium with its vapor phase at the vaporization temperature relevant to the field in question, the movement of the heat transfer medium being generated by a difference of state and not by a pumping element.

According to the present disclosure, two types of heat pipe are used in combination.

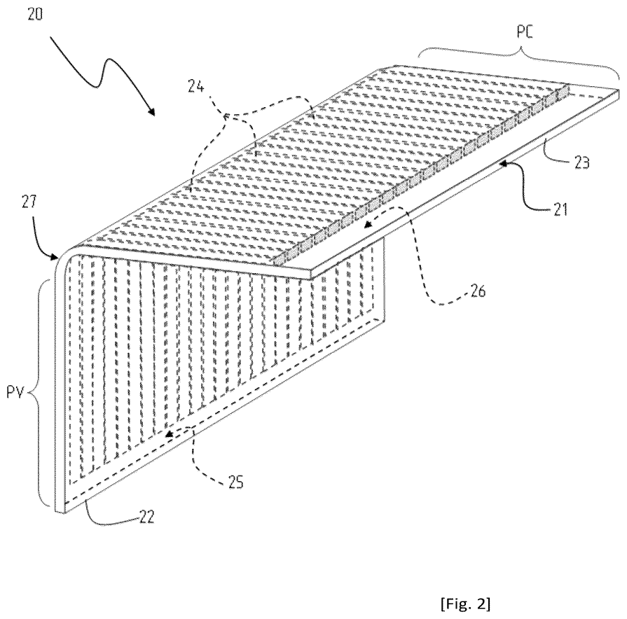

The first type of heat pipe is referred to as “gravity” and is illustrated in FIG. 2.

A gravity heat pipe 20 according to the present disclosure has a bent body 21 with two ends 22-23 and internally integrating a series of juxtaposed parallel microchannels 24 containing a heat-carrying substance.

At each of the ends 22-23 of the heat pipe is a transverse volume, 25 and 26 respectively, into which the channels open, so that they communicate fluidically with each other via these transverse volumes 25 and 26. The latter thus enable fluid (communicating vessel principle) and/or pressure (such as in the vapour phase) balancing at the ends of the heat pipe.

The first end 22 of the gravity heat pipe is intended to be arranged, in the position of use, in heat exchange capacity with a hot part of the cells (the second and/or third side), and the second end 22 of the gravity heat pipe is intended to be arranged, in the position of use, in heat exchange capacity with a hot part of the cells (the second and/or third side). second end 23 of the gravity heat pipe is designed to be arranged, in position of use, in heat exchange capacity with a heat source of a second heat exchange device, which will be described in more detail below. continued.

Thus, the first end 22 of the bent gravity heat pipe has a vaporization section PV where the heat-carrying substance can be vaporized. heated to the point of vaporization by calories from at least one of the cells, and the second end 23 of the bent gravity heat pipe has a part of PC condensation where the caloporteuse substance can be cooled to the point of condensation by heat exchange with the cold source of the second heat exchange device.

In other words, in a gravity heat pipe, the condensation section PC is located at a higher elevation than the vaporization section PV with respect to gravity.

The first type of heat pipe is therefore referred to as “gravitational”, in the sense that the internal geometry of the channels 24 and transverse volumes 25 and 26 ensures that the heat-carrying substance returns from the condensation section PC to the vaporization section PV by gravity, as opposed to capillary heat pipes where fluid displacement occurs by capillary action thanks to a porous material, or wick, present in the heat pipe channels. Capillary heat pipes are therefore outside the scope of the present disclosure.

The gravity heat pipes used in the present disclosure as a first heat exchange device can be of several operating modes: flooded, thermosiphon or pulsed. The arrangement according to the present disclosure offers efficient thermal performance with gravity heat pipes having a hybrid operating mode between thermosiphon and pulsed. This Hybrid operation means that a succession of vapour pockets separated by liquid will circulate by gravity difference from the evaporation zone to the condensation zone. In pure thermosyphon, the bubbles gather in the center of the channel, until only vapor remains. rises to the condensation zone.

This succession of vapour pockets provides a high level of efficiency. optimal heat exchange.

In the vaporization section, or evaporator, the liquid is heated by the cells in thermal contact with the evaporator. The liquid evaporates until it reaches the condensation section, or condenser, in which the liquid is evaporated. steam is condensed. The condenser is in thermal contact with the cold source of the second heat exchanger (described below), which removes the heat transported by the heat pipe from the second and/or third side of the cells. The condensate then returns to the evaporator, by gravity. The liquid then undergoes further evaporation/condensation cycles to remove heat from the cells to the cold source.

For the heat pipe to operate by gravity, the channels enclosed in the sealed body stand upright, with the condensing section located at a higher elevation than the vaporizing section with respect to gravity.

Under these conditions, the curved section 27 located between the vaporization section and the condensation section “must be understood as located between the end 22 of the vaporization sections PV and the opposite end 23 of the condensation section PC, along the main elongation direction of the heat pipe channels. The curved part is an adiabatic intermediate zone, where the heat-carrying substance undergoes little or no heat transfer. heat exchange.

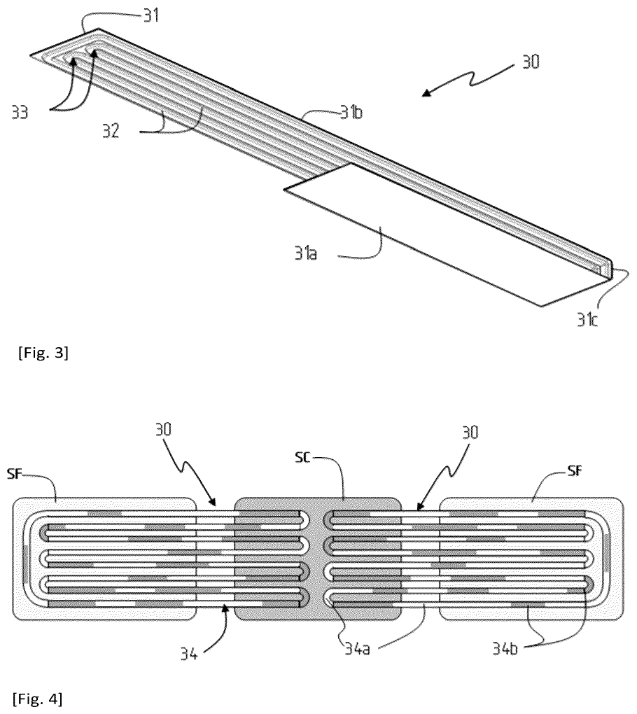

The second type of heat pipe is called “pulsed” and is illustrated in FIGS. 3 and 4.

As illustrated in FIG. 3, a pulsed heat pipe 30 used in the present disclosure comprises a body 31 internally integrating at least one channel 32 (or tube) closed on itself to form a loop and incorporating a heat-carrying substance.

The channel 32 has circumvolutions 33 (i.e. curved sections succeeding straight or inverted curved sections) to form a serpentine of length much greater than the length of the body 31 of the pulsed heat pipe 30.

The body of the pulsed heat pipe 30 according to the present disclosure is bent at C so as to present:
a first wing 31a comprising the evaporation portion intended to be arranged in heat exchange capacity with at least part of the first side or fourth side of the cell edge,
a second wing 31b parallel to the first wing 31a and comprising the condensation part intended to be arranged in heat exchange capacity with at least one cold plate; and
a core 31c connecting the first wing 31a and the second wing 31b.

Thus, channel 32 extends between the evaporation portion located in first wing 31a and intended to be in thermal contact with a hot surface of the cells (the first or fourth side of the cell edge), and a condensation portion located in second wing 32b and intended to be in thermal contact with a face of a cold plate.

FIG. 4 is a schematic representation of the operating principle of two pulsed heat pipes 30 arranged flat between a hot surface SC and a cold surface SF. It should be noted that the cold surface has a larger surface area than the hot surface. heat exchange with the pulsed heat pipe 30 than the hot surface. This principle is also applied in the embodiments of the present disclosure.

In use, the heat-carrying substance 34 evaporates locally in the evaporation section in heat-exchange capacity with the hot surface SC, and by pressure rise is directed towards the condensation section arranged in heat-exchange capacity with the cold surface SF. At the same time, the heat-carrying substance condenses locally in the condensation section and, by lowering the pressure, moves towards the evaporation section.

This results in the formation of a succession of steam bubbles 34a and liquid portions 34b in the channel, and a natural circulation in
closed loop between evaporating and condensing parts,
allowing heat to be transferred from the evaporator section to the condensation part.

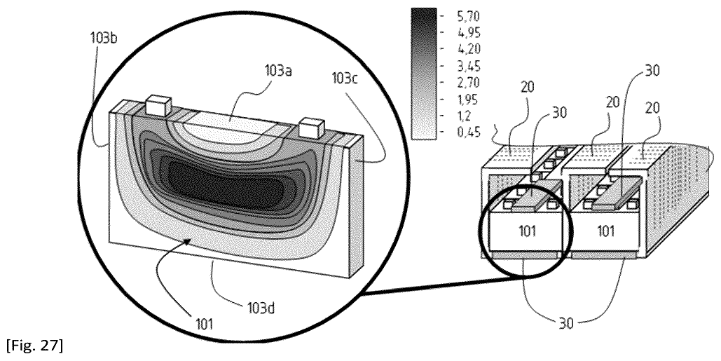

The present disclosure uses a combination of these two types of heat pipe, which not only improves heat dissipation, but also enhances heat homogeneity within the cells. In other words, this combination makes it possible to obtain a temperature gradient between the hottest and coldest points of the cell being loaded that is both narrower and has a lower highest temperature than is obtained with just one of the heat pipe types. This is illustrated and described in relation to FIGS. 26 and 27.

This makes it possible to achieve a temperature difference between the hottest and coldest parts of the cells (also known as the “temperature gradient”) of between 5 and 7 degrees Celsius, whereas only one type of heat pipe (such as the gravity heat pipe) is capable of achieving a temperature gradient of less than 25 degrees Celsius, which is already much lower than that achievable with the cold plates of the prior art.

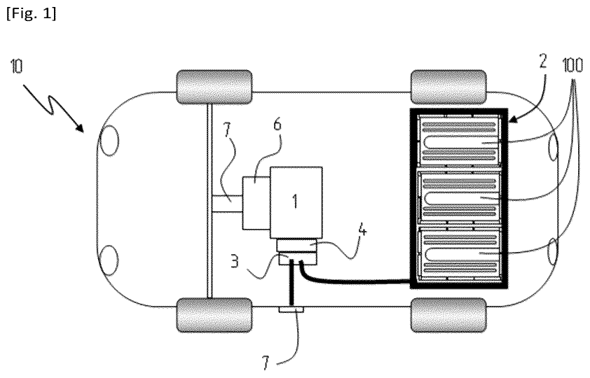

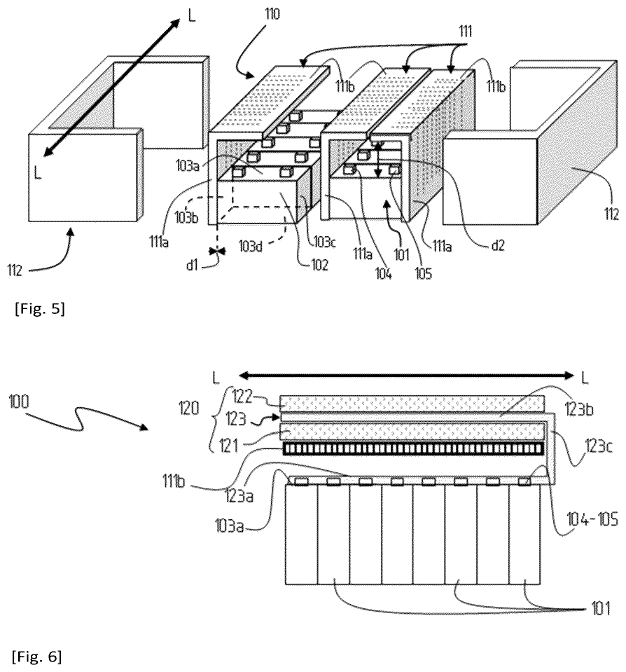

FIGS. 5 to 25 show a thermally controlled device 100 for storing electrical energy in chemical form for a vehicle 10 shown in FIG. 1.

The device according to the present disclosure is intended for an electric or hybrid vehicle 10. As shown in FIG. 1, this vehicle comprises an electric motor 1, powered by a storage battery 2 connected to the motor 1 and, if it is a hybrid, to an electric generator (not shown). In addition to the electric motor 1 and battery 2, the vehicle 10 includes a control unit 3, an AC/DC charger/converter 4, a transmission 5 and a differential 6.

The ECU 3 controls energy flows via a number of sensors. It also manages recharging of the battery 2 when the vehicle 10 is connected to a charging station. For example, when a temperature sensor indicates that a battery module or part of a battery module or a cell in a battery module exceeds the safety temperature during charging (usually 45° C.), ECU 3 reduces the charging current, which extends the charging time of the battery, but preserves its integrity.

The cells of battery 2 supply the electrical energy stored in them. They are rechargeable, via an electrical socket 7 connected to it through the ECU 3 and the AC/DC charger/converter 4 (or a functional equivalent directly integrated into the battery modules; see below).

Since the battery 2 delivers direct current (DC) and the electric motor uses alternating current (AC), the vehicle 10 also includes an AC/DC charger/converter 4.

Its primary function is to convert DC current from the battery into AC current for use by the motor.

The AC/DC charger/converter 4 also enables the battery to be charged by an AC charging station, by converting AC current into DC current for the battery 2, and/or by a DC charging station, the latter type of charging being the fastest, as the DC current is directly “injected” into the battery 2 without conversion.

In a new generation of battery modules 2, the function of the AC/DC charger/converter 4 is performed by components directly integrated into each battery module, making them controllable independently of each other, and saving space in the vehicle. In addition to transforming battery current to the motor, this also enables AC current to be converted to DC current for the cells of battery 2 when the vehicle is connected to an AC terminal, or inject DC current directly, without conversion, into the cells of battery 2 when the vehicle is connected to a DC terminal.

In other words, by integrating the charger/converter function AC/DC 4 directly into each battery module, we can do without of an external AC/DC 4 charger/converter, while allowing direct AC charging and discharging of the battery. This means you don't need a charger (AC/DC) when charging, and a converter when discharging (DC/AC).

Thermal management of the battery, for example Thermal management in the case of AC direct current is all the more critical for maintaining the ideal temperature during charging and discharging operations. Thermal management in the case of direct AC current will be all the more critical for maintaining the ideal temperature during charging and discharging operations.

The current constraints are as follows:
The maximum temperature within any battery cell (pocket or prismatic; see definitions below) must be less than 45° C.;
The difference between the maximum and minimum temperature within any battery cell must be less than 6° C., for example 4° C. or 3° C.;
The difference between the maximum temperature of two cells or modules (sets of cells) must not exceed 5° C.

According to the present disclosure, the battery 2 is composed of a set of thermal management devices 100, enabling the battery 2 (cells and modules) to be temperature-controlled (amplitude, but also homogeneity of temperature gradient within the cells and within the modules), and even to be mechanically protected, so that it does not overheat, at least when it is operating, such as when it is being recharged with electrical energy.

A thermally controlled device 100 according to the present disclosure is illustrated. partially shown in FIG. 5, only its first heat exchange device is illustrated in combination with the cells, for the sake of clarity. figure and the description of this part of the present disclosure.

The thermally controlled device 100 comprises a plurality of electrical cells 101, also known as accumulators, arranged parallel to one another along a longitudinal direction L-L.

The cells 101 each have two faces 102 connected by a slice 103 where the cell is thinnest and which runs around the cell. On this edge 103 are located a first side 103a, a second side 103b, a third side 103c, and a fourth side 103d on which the cell 101 rests in the position of use.

The second and third sides 103b-103c are parallel to each other and transverse to the first side 103a and the fourth side 103d.

Each cell 101 comprises a cathode terminal 104 and a cathode terminal 105. anode terminal 105 located on a single side (first side 103a) or on two different sides (second side 103b and third side 103c) of the wafer 103, depending on the cell type:
the prismatic cells (shown in FIG. 5) carry the cathode terminal 104 and the anode terminal 105 on the first side 103a;
the pouch cells carry the cathode terminal 104 on the second side 103b and the anode terminal 105 on the third side 103c, or vice versa.

Each terminal 104-105 projects from the side carrying it. The terminals 104, respectively 105 of adjacent cells are connected together to form the battery, by means of connecting cables or combs (not shown in the figures), the cells being arranged parallel to each other, along the longitudinal direction L-L, face 101a against face 101a.

In both cases, any cell 101 is substantially parallelepipedic, with four sides, two by two adjacent and transverse, successively along its edge 103. On the periphery, or edge, the In finer detail, the first 103a and fourth 103d sides are the longest; these are the horizontal sides, respectively upper and lower with reference to the position of use. The second 103b and third 103c sides are the shortest; these are typically the vertical, lateral sides, respectively left and right, cell seen from the front, on one of its two largest opposite faces 102.

As known:
a prismatic cell is a cell with an external rigid envelope or rigid body in the shape of a rectangular parallelepiped where the first side, the second side, the third side and the fourth side are located, and
a pouch cell has an outer envelope or flexible body where the first side, second side, third side and fourth side are also located. A pouch cell is so called because of its bag or pouch format.

As shown in FIG. 5, the 100 device further comprises a first heat exchange device 110 comprising three heat pipes In addition, the “gravity” cells 111 are capable of heat exchange with a second 103b and/or third 103c side of the cells 101, and with a cold source of a second heat exchange device 120, not shown in this figure.

As explained above, the gravity heat pipe 111 used in the present disclosure as the first heat exchange device has an internal channel geometry that ensures that the return of the heat-carrying substance from the condensation section to the vaporization section takes place by gravity.

In the arrangement according to the present disclosure, the gravity heat pipes 111 face the second 103b and/or third 103c side of the cells, and they have a first upright flange 111a, substantially vertical in the position of use, then are bent (aforementioned bend), then have a second flat, i.e. substantially horizontal, wing 111b, which extends at least over part of the first side 103a of the (each) relevant cell 101. In other words, the second, flat 111b wing may lie above all or part of the first side 103a and/or below all or part of the fourth side 103d opposite the first side 103a.

This covers L-, U- and C-shapes. With an L or C shape, this is considered from bottom to top. With an inverted U-shape, after the second horizontal (flat) 111b flange, the heat pipe continues with a second bend and then descends again, presenting a third upright, substantially vertical flange, similar to the first upright 111a flange.

The (each) upright wing 111a includes the vaporization portion. The flat-extending wing 111b includes the condensation portion. In other words, the heat pipe, and hence the channels, can be considered to be bent in the adiabatic zone between the successive vaporization and condensation sections.

The channels, which thus extend (each and together) between their ends, can communicate fluidically with each other, at one and/or other of these ends, thus at the lower end of the vaporization part and at the upper end of the condensation part.

The liquid phase of the heat transfer medium can then flow from one channel to the other at the base of the heat pipe, as can the vapor phase at the end of the condensation section.

In this way, the channels of the gravity heat pipe(s) extend parallel to the cell edge, vertically then horizontally.

The bend radius will thus be a compromise between:
fluid continuity in the channels at this point,
a first minimum distance d1 (such as zero to obtain a support) of the vaporization part of the heat pipe facing (or against in case of contact) the first, second or third side of the cell (or of each cell) located opposite the vaporization part (side
without cathode and anode terminals),
a second distance d2, strictly greater than the first distance (projection of the cathode and anode terminals on the first side carrying them), sufficient to allow condensation in the condensation section of the horizontal 111b wing.

For mechanical/thermal synergy, the first distance is set to zero by blocking the vertical wing 111a of the heat pipes 111 against the second 103b and/or third 103c sides of the cells (or the terminals carried by these sides for pocket cells). As the 111 gravity heat pipes are rigid, this horizontal blocking ensures that they are also vertically blocked, in the sense that the 111b horizontal wing remains at the second distance from the first side 101a of the cells.

As illustrated in FIG. 5, the first heat exchange device 110 further comprises clamping means 112 configured to clamp the vertical flange 111a of each heat pipe 111 against the second side 103b and/or the third side 103c of the opposing cell(s), so that the or each vaporizing portion is pressed against the opposing cell(s).

For example, clamping means 112 consists of two C-pieces that encircle the heat pipes at their vaporization part, so as to constrain them against the cells when the assembly is inserted into the housing (not shown) of the assembly. In other words, clamping means 112 act as a clamping spacer between the upright walls of the housing and the vaporizing parts of the heat pipes.

Alternatively, the clamping means may comprise a spring bearing against the vaporizing portion of the heat pipes and against either a spacer or the housing walls, so as to force the vaporizing portions of the heat pipes against the second side and/or the third side of the facing cell(s).

If the thermally controlled energy storage device electrical system comprising only one or several gravity heat pipes is entirely satisfactory, the second distance between the horizontal part of the heat pipe and the first side of the cells must be large to allow condensation in the upper part of the heat pipe despite the heat released by the first side of the cell. As a result, the size of the device is relatively large in relation to the amount of heat removed.

The idea behind the present disclosure is to take advantage of the constraints of the previous gravity heat pipe to transform them into an advantage and enable superior heat removal.

Thus, according to the present disclosure, the device uses the space located between the condensation part of the gravity heat pipe(s) and the first side of the cells to recover the heat emitted by this first side and evacuate it away from the cell and the gravity heat pipe, facilitating condensation within this gravity heat pipe and thus improving its efficiency and the temperature distribution within the cell by synergy effect.

According to the present disclosure, the thermally controlled storage device of electrical energy includes a second heat exchange device 120 illustrated in FIGS. 6 to 15.

In the first embodiment shown in FIG. 6, the second heat exchange device 120 comprises a cold source 121-122 and a pulsed heat pipe 123.

The cold source 121-122 is used for condensation in the gravity heat pipe(s) 111 of the first heat exchange device and for condensation in the pulsed heat pipe(s) 123.

The cold source comprises at least a first cold plate 121 and a second cold plate 122 through which a heat transfer fluid flows between an inlet 124a and an outlet 124b (see FIG. 12). The first 121 and second 122 cold plates extend parallel to each other. between them, longitudinally, flat and facing the first side 103a of the 101 cells.

The pulsed heat pipe 123 comprises a C-bent body to present:
a first wing 123a extending longitudinally between the first side 103a of the edge 103 of the cells 101 and the condensation part 111b of the gravity heat pipe(s) 111, and comprising the evaporation part,
a second wing 123b, parallel to the first wing 123a, and comprising the condensation part;
a web 123c connecting the first wing 123a and the second wing 123b.

According to the present disclosure, the first wing 123a is capable of heat exchange with at least a portion of the first side 103a of the edge 103 of the cells 101, so that it is interposed between this first side 103a of the cells and the condensation portion 111b of the gravity heat pipe 111 of the first heat exchanger 110.

Since the first wing 123a comprises the vaporization section of the pulsed heat pipe 123, it captures heat from the first side 103a of the cells, which does not diffuse to the condensation section 111b of the gravity heat pipe 111, despite the distance separating it from the first side 103a of the cells.

Thus, at the same distance as in previous devices, condensation of the condensation section 111b of the 111 gravity heat pipe is easier.

As a corollary, with condensation identical to that obtained in the previous devices, it is possible to reduce the distance between the condensation part 111b of the gravity heat pipe 111 and the first side 103a of the cells (provided that sufficient space is left to slide the the first wing 123a of the pulsed heat pipe 123), thus improving the compact design.

In other words, the second heat exchange device 120 not only acts on its own to regulate cell temperature, but also has a synergistic effect on the entire controlled device. This is achieved by improving the efficiency of the first heat exchange device 110, and by reducing the amplitude of the temperature gradient between the hottest and coldest points of each cell.

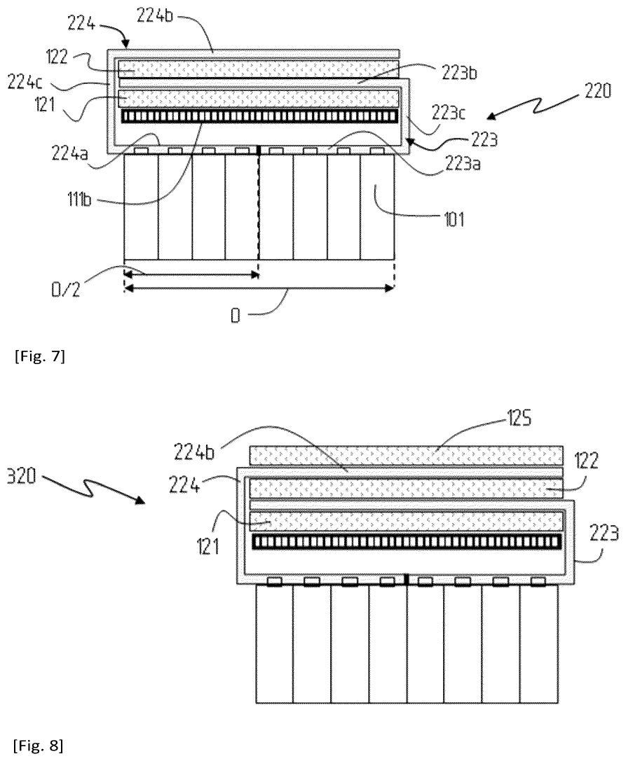

FIGS. 7 and 8 and FIGS. 10 to 15 illustrate different embodiments of the The second heat exchanger is more thermally efficient than the first in FIG. 6, and is suitable for large cell (or module) assemblies. For such large modules, two pulsed heat pipes can be arranged face-to-face.

In a first option illustrated in FIGS. 7, 8, and 10 to 12, each of the evaporation zones is arranged to cover a portion (usually half the length) of the first side of the module cell edge. In this case, the evaporation zones face each other in the same plane.

In a second option, illustrated in FIGS. 13 to 15, the evaporation zone of a first pulsed heat pipe is arranged along the entire length of the first side of the module cell edge, and the zone of a second pulsed heat pipe is arranged along the entire length of the fourth side of the module's cell edge. The condensation zones are always one above the other, separated by a cold plate cooling channel.

In the second embodiment shown in FIG. 7, the second heat exchange device 220 comprises a first pulsed heat pipe 223 and a second pulsed heat pipe 224 of two different types, referred to as A and B in the remainder of this description.

In both types A and B of pulsed heat pipe 223-224, the first wing 223a-224a of each of the pulsed heat pipes 223-224 extends longitudinally between the first side 103a of the cell slice 103 101 and the condensation section 111b of the gravity heat pipe(s) 111. Each of the first wings 223a-224a is in heat exchange capacity with only a first half-length D/2 of the first side 103a of the slice 103 of the cells 101, so that together, the first wings 223a-224a of the pulsed heat pipes 223-224 are in longitudinal thermal contact with the entire first side 103a of the slice 103 of the cells 101.

The first pulsed heat pipe 223 is of type A, according to which the second wing 223b extends between the first and second cold plates and is in heat exchange capacity with them.

The second pulsed heat pipe 224 is of type B, according to which the second wing 224b of the second pulsed heat pipe 224 extends in heat exchange capacity with a free face of the second cold plate 122. By free face of the second cold plate 122 is meant the face which is not in contact with the second wing 223b of the first pulsed heat pipe 223.

The two types A and B of pulsed heat pipeseach have a surface area in heat exchange capacity with the hot source (the half-length of the 101 cell edge) that is smaller than the surface area in heat exchange capacity with the cold source (equal to at least one cold plate face).

Thus, for the same width, the heat pipes have, through their first wing 223a-224a, a heat exchange capacity length of only half the length D/2 of the first side 103a of the edge 103 of the cells 101, while their respective second wings 223b-224b have a heat exchange capacity length equal to the length D of the cold plates.

This arrangement promotes efficient heat dissipation.

FIG. 8 illustrates a third, even more efficient embodiment 320, in which the cold source of the second heat exchange device comprises a third cold plate 125.

In this embodiment, the third cold plate 125 is arranged parallel and opposite the second cold plate 122, in heat exchange capacity with the second wing 224b of the second pulsed heat pipe 224.

In other words, the third cold plate 125 is a so-called “terminal” cold plate which covers the upper face of the condensation part 224b of the second pulsed heat pipe 224 and thus caps the whole assembly.

The addition of this third cold end plate provides two heat exchange faces for the condensation part 224b of the second pulsed heat pipe 224, thus improving heat removal from the cells 101.

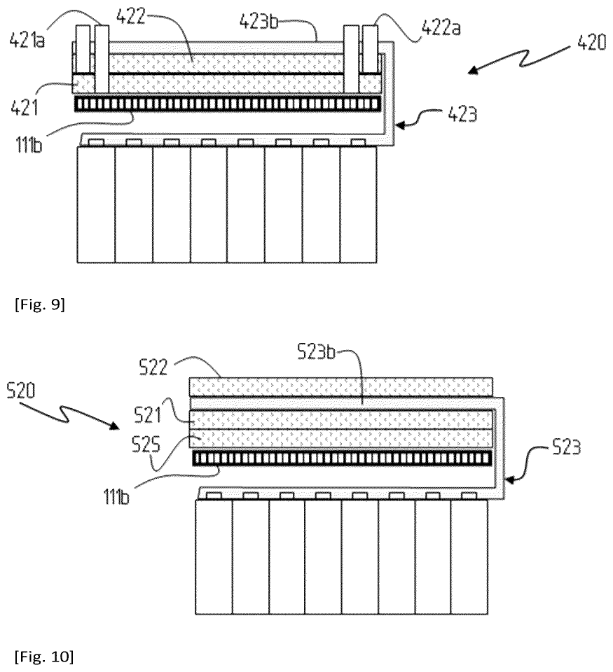

FIG. 9 illustrates the possibility of specializing cold sources and heat dissipation circuits between the gravity heat pipes of the first heat exchanger and the pulsed heat pipes of the second heat exchanger.

The vaporization section of the pulsed heat pipe is interposed between the first side of the cell slice and the gravity heat pipe.

Thus, the fourth embodiment of the second device The heat exchanger 420 of FIG. 9 still comprises two cold plates 421 and 422, but these two cold plates are arranged one against the other.

In addition, the first cold plate 421 is connected to a first heat transfer fluid circuit 421a and the second cold plate 422 is connected to a second heat transfer fluid circuit 422a independent of the first heat transfer fluid circuit 421a.

In this arrangement, the first cold plate is in heat-exchange capacity with the condensation part 111b of the gravity heat pipe, and the second cold plate is in heat-exchange capacity with the condensation part 423b of the pulsed heat pipe 423.

In this way, the calories absorbed by the first cold plate 421 are discharged in a first circuit 421a, and the calories absorbed by the second cold plate 422 are discharged in a second circuit 422a, which improves condensation in the condensation section 111b of the gravity heat pipe and in the condensation section 423b of the pulsed heat pipe 423.

This double cold plate arrangement is interesting, as it increases heat exchange capacity and ensures optimum evaporation in gravity and pulsed heat pipes.

In addition, by separating the heat dissipation circuits, i.e. the cold sources, circulation in the cold plates can be optimally adapted to the different operating modes of the gravity heat pipes and the pulsed heat pipes,

FIGS. 10 to 12 illustrate embodiments similar to FIGS. 6 to 8, but incorporating a double cold plate in place of a single cold plate between the gravity and pulsed heat pipes. The heat transfer fluid circuits are not illustrated in these figures for the sake of clarity.

Thus, in the fifth embodiment shown in FIG. 10, the cold source of the second heat exchange device 520 comprises a first cold plate 521, a second cold plate 522 and a third cold plate 525. The third cold plate 525 is arranged against the first cold plate 521, in heat exchange capacity with the gravity heat pipe(s) 111. The first cold plate is arranged for heat exchange with the second condensation fin 523b of the pulsed heat pipe 523. The second cold plate 522 is arranged parallel to and opposite the first cold plate 521, in heat exchange capacity with the second condensation wing 523b of the pulsed heat pipe 523. with the second wing 523b of the pulsed heat pipe 523.

In other words, the second cold plate 522 is an end cold plate which covers the upper face of the condensation part 523b of the pulsed heat pipe 523 and thus caps the whole assembly.

In addition, the first and second cold plates are connected to a first heat transfer fluid circuit (not shown) and the third cold plate is connected to a second heat transfer fluid circuit (not shown), independent of the first heat transfer fluid circuit.

In this embodiment, the calories absorbed from the pulsed heat pipe 523 by the first and second cold plates 521-522 are discharged in a first circuit, and the calories absorbed from the gravity heat pipe 111 by the third cold plate 525 are discharged in a second circuit, which improves condensation in the condensation section 111b of the gravity heat pipe and in the condensation section 523b of the pulsed heat pipe 523.

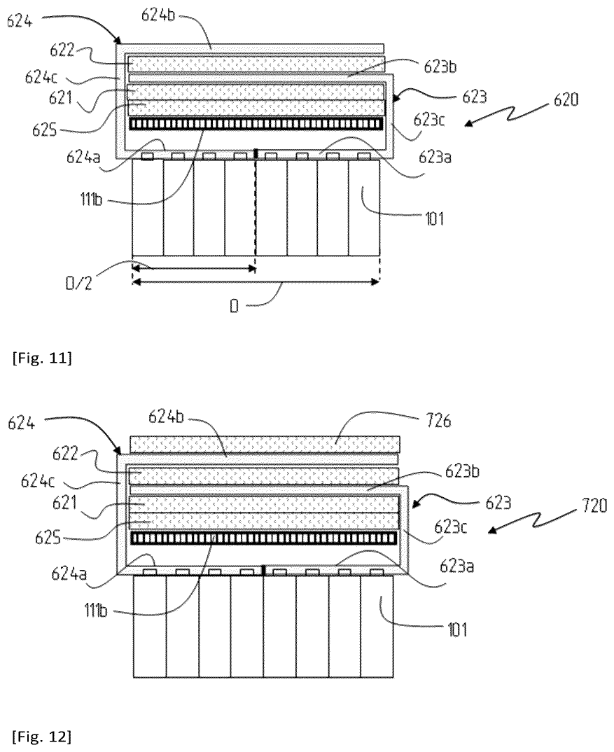

FIG. 11 illustrates the possibility of using two pulsed heat pipes of two different types A and B with a cold source comprising a double cold plate.

This sixth embodiment is therefore similar to that shown in FIG. 7, with the difference that instead of using a single cold plate between the gravity heat pipe and the pulsed heat pipe, a double cold plate is used.

More precisely, the second heat exchange device 620 comprises a first pulsed heat pipe 623 of type A and a second pulsed heat pipe 624 of type B, similar to what has been described in relation to FIG. 7.

In contrast to the design shown in FIG. 7, the first pulsed heat pipe 623 has a second wing 623b extending between the first cold plate 621 and the second cold plate 622, and is capable of heat exchange with them.

The gravity heat pipe 111 has the following heat exchange capacity with a third cold plate 625 forming with the first plate cold plate 621 a double cold plate, i.e. the first plate 621 and the third cold plate have a face in contact with each other.

The second pulsed heat pipe 624 is of type B, according to which the second wing 624b of the second pulsed heat pipe 624 extends in heat exchange capacity with a face of the second cold plate 622 which is not in contact with the second wing 623b of the first pulsed heat pipe 623.

This arrangement has the same advantages as that shown in FIG. 7, with greater heat removal capacity thanks to the double cold plate and the separation of the fluid circuit of cold plates 621 and 622 in heat exchange capacity with pulsed heat pipes 623 and 624, and of the fluid circuit of cold plate 625 in heat exchange capacity with gravity heat pipe(s) 111.

The seventh embodiment of the second heat exchange device 720 of FIG. 12 is similar to that of FIG. 11, but additionally comprises a fourth cold end plate 726, capping the assembly, and in heat exchange capacity with the face of the second heat exchange device 720. second wing 624b of the pulsed heat pipe 624 which is not in contact with the second cold plate 622.

This is one of the optional designs, as it combines all the above advantages: separate heat transfer fluid circulation circuits between the cold plate in contact with the gravity heat pipe(s) and the cold plates in contact with the pulsed heat pipes, use of pulsed heat pipes of two different types, each absorbing heat from part of the first side of the cells, and discharging it via a second condensation wing in heat exchange capacity with two cold plates each.

As previously mentioned, FIGS. 13, 14 and 15 illustrate a second option for arranging pulsed heat pipes to further reduce the amplitude of the temperature gradient within each cell.

FIGS. 13, 14 and 15 illustrate a third type of pulsed heat pipe, referred to as Type C in the remainder of this description, for capturing calories from the fourth side of the cells.

In the eighth embodiment shown in FIG. 13, the second heat exchange device 350 comprises a first pulsed heat pipe 351 of type A, and a second pulsed heat pipe 352 of type C.

The first type A pulsed heat pipe 351 comprises a first wing 351a extending longitudinally between the first side 103a of the slice 103 of the cells 101 and the condensation part 111b of the gravity heat pipe(s) 111. The first wing 351a is capable of heat exchange with a complete length D of the first side 103a of the slice 103 of the cells 101, i.e. with the entire first side 103a of the slice 103 of the cells 101.

As previously explained, the first pulsed heat pipe 351 of type A has a second wing 351b extending between the first 121 and second 122 cold plates and is in heat exchange capacity with them.

Unlike the type A heat pipe, the second type C pulsed heat pipe 352 comprises a first wing 352a extending longitudinally in heat-exchange capacity with the fourth side 103d of the slice 103 of the cells 101, and it extends over a full length D of the fourth side 103d of the slice 103 of the cells 101, i.e. with the entire fourth side 103d of the slice 103 of the cells 101.

The second type C pulsed heat pipe 352 has a second wing 352b extending between the second 122 and third 125 cold plates and is in heat exchange capacity with them.

The two types A and C of pulsed heat pipes each have a smaller surface area in heat exchange capacity with the hot source (the length of the cell slice 101) than the surface area in heat exchange capacity with the cold source (corresponding to two cold plate lengths).

Thus, heat pipes 351 and 352 have, by their first flange 351a-352a, a length in heat exchange capacity equal to a length D of the first side 103a and the fourth side 103d of the edge 103 of cells 101, while their respective second flange 352b-352b have a length in heat exchange capacity equal to two cold plate lengths D, since the second wing is in heat exchange capacity with two cold plates.

This arrangement promotes efficient heat removal and significantly reduces the amplitude of the temperature gradient within each cell, since heat is removed from four sides of the cells: the second and third sides by gravity heat pipes and the first and fourth sides by pulsed heat pipes.

This efficiency is even more pronounced with the use of a double cold plate between the first pulsed heat pipe and the gravity heat pipe.

This is illustrated in the ninth embodiment in FIG. 14. 0174] As in FIG. 13, the second heat exchange device 750 includes a first pulsed heat pipe 751 of type A, and a second pulsed heat pipe 752 of type C.

In this embodiment, the first pulsed heat pipe 751 of type A has a second flange 751b extending between the first 621 and the second 621. second 622 cold plate and is able to exchange heat with them.

The gravity heat pipe is capable of heat exchange with the third cold plate 625 forms with the first cold plate 621 a double cold plate, i.e. the first cold plate 621 and the second cold plate 622. third cold plate 625 have one face in contact with the other.

The second C-type pulsed heat pipe 352 has a second wing 352b extending between the second cold plate 622 and a fourth cold plate 625, and is in heat exchange capacity with them.

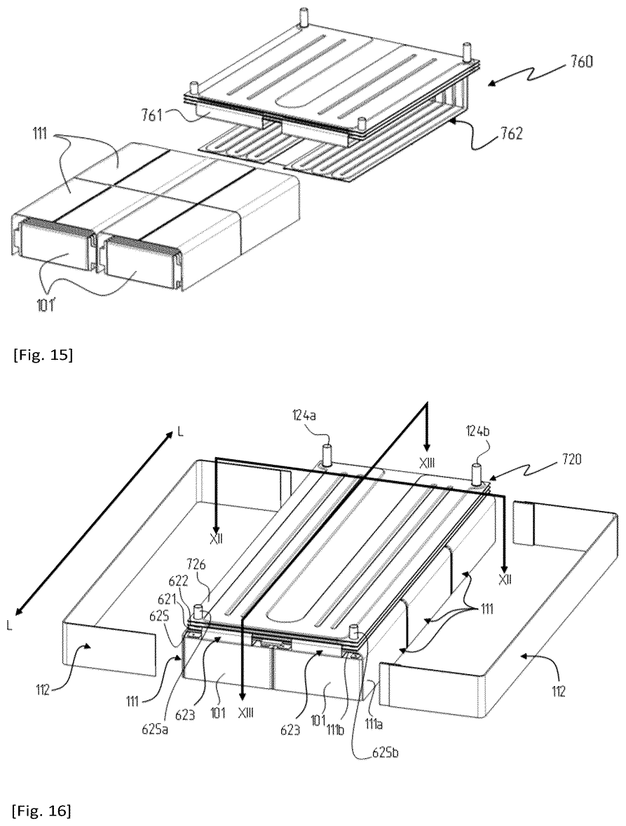

The tenth embodiment 760 illustrated in FIG. 15 shows, from the implementation of pulsed heat pipes 761-762, type A and type C respectively, with pocket cells 101′ having their terminals on the second and third sides, facing the vaporization part of the gravity heat pipes 111.

The use of 762 type C pulsed heat pipes is interesting with pocket cells, as it enables very homogeneous thermal regulation to be achieved in each cell, from all four sides, and in a symmetrical manner.

It is also understood that the embodiments of the present disclosure illustrated with prismatic cells are adaptable to pocket cells and vice versa.

FIG. 16 illustrates a realistic perspective view of a first variant of FIG. 12.

In this first illustrated variant, with reference to the position use, the second heat exchange device 720 comprises frontally (i.e. in the foreground of the figure), two pulsed heat pipes 623 of type A, i.e. whose second wing is located between the first cold plate 621 and the second cold plate 622.

At the rear, not visible due to the perspective, the second heat exchange device comprises two type B pulsed heat pipes 624, i.e. the second wing of which is located between the second cold plate 622 and the fourth cold plate 726.

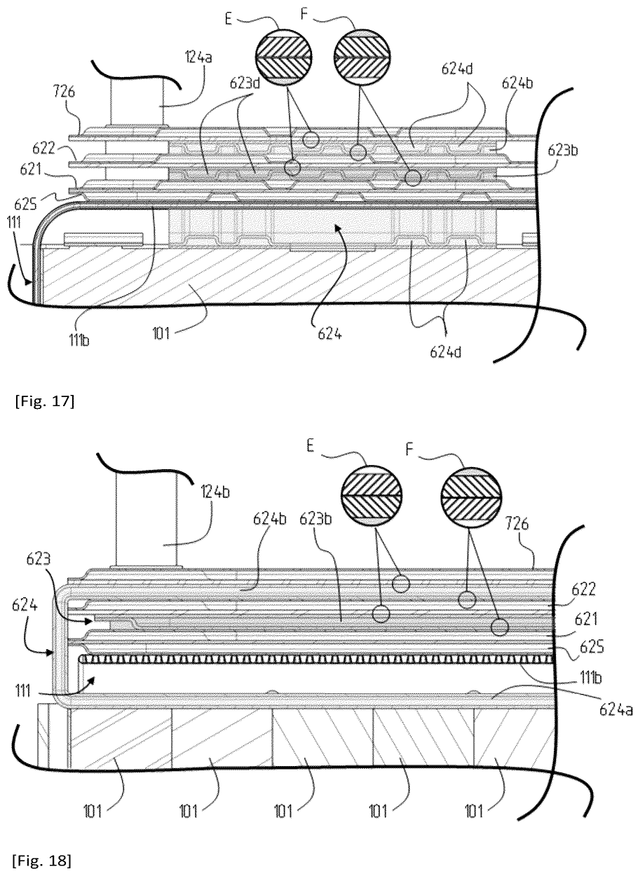

FIG. 17 is a partial cross-section along line XII-XII of FIG. 16, showing the stack of heat pipes 111-623-624 alternating with cold plates 621-622-625-726, and an example of the internal structure of the various components.

It is thus noted that in the structure of the double cold plate 621-625, the two cold plates are applied against each other by one of their faces, and the first cold plate 621 is in heat exchange capacity with the wing 623b of the pulsed heat pipes 623, while the cold plate 625 is in heat exchange capacity with the wing 623b of the pulsed heat pipes 623. in heat exchange capacity with the 111b wing of the gravity heat pipes 111.

The channel structure of pulsed heat pipes is also distinguished: pulsed heat pipe 623 has a channel 623d, and pulsed heat pipe 624 has a channel 624d.

FIG. 18 is a partial longitudinal section along line XIII-XIII of FIG. 16, showing the C-shaped structure of pulsed heat pipe 624, type B, and a partial view of the second wing 623b of pulsed heat pipe 623.

This example has the advantage of manufacturing a second heat exchange device according to the present disclosure with stacked standard cold plates, the only modification being the fluidic connection of the cold plates in contact with the pulsed heat pipes (see FIG. 22). The disadvantage is the doubling of the walls in contact with the cold plates and pulsed heat pipes. In other words, each exchange surface is made up of two walls which form a resistance and increases the thickness of the entire structure. second heat exchanger.

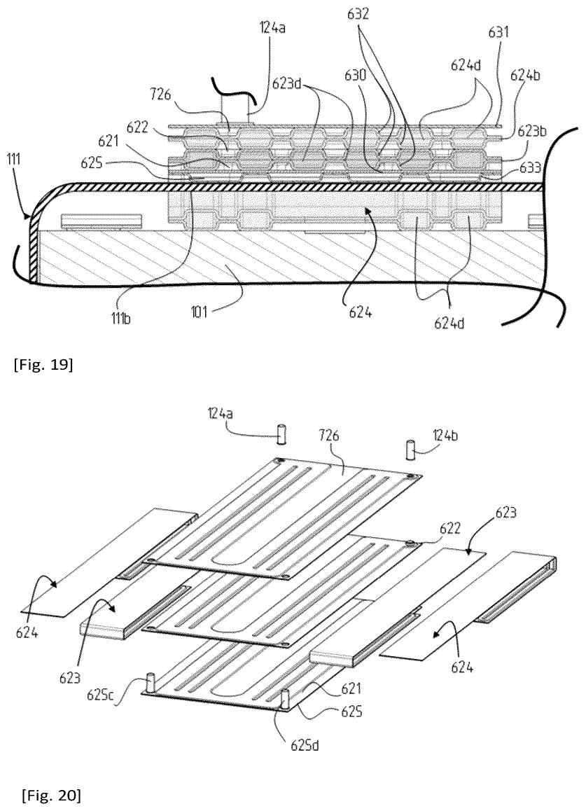

A further example of the internal structure of the various components is shown in FIG. 19.

In previous embodiments, each element (cold plate/pulsed heat pipe) comprised its own structure, and the assembly was the result of the stacking of each of these elements in thermal contact. Now, each cold plate and pulsed heat pipe comprises two outer walls separated by a corrugated inner wall delimiting the channel or channels. Their stacking results in two external walls of two juxtaposed elements lying against each other. The resulting thickness separating two channels is therefore doubled.

For example, in the case of the structure shown in FIGS. 17 and 18, enlargement E illustrates the stacking of the outer wall of a cold plate above the outer wall of a pulsed heat pipe, and enlargement F illustrates the stacking of the outer wall of a pulsed heat pipe above the outer wall of a cold plate.

Within the scope of the present disclosure and as illustrated in FIG. 19, it may be useful to realize the cold plate and pulsed heat pipe assembly in a single block in which the separation between the channel of a pulsed heat pipe and the channel of a cold plate consists of a single wall. Functionally identical elements bear the same references as in FIG. 17, so that the analogy can be understood.

In other words, the cold plates and pulsed heat pipe(s) form a single block within which the cold plates and pulsed heat pipe(s) are functionally separated from each other by a single wall. This means that this block provides the functionality of both pulsed heat pipes and cold plates with a single separating wall between a channel providing the cold plate function and a channel providing the pulsed heat pipe function.

Thus, in the illustrated embodiment, the block comprises two flat walls 630 and 631, between which are placed four corrugated walls 632. This forms the channel 623d of the pulsed heat pipe 623, the channel 624d of the pulsed heat pipe 624, and the cold plate channels 621, 622 and 726.

Below the bottom flat wall 630, a corrugated wall 633 is fixed, forming the channel of the cold plate 625 in contact with the gravity heat pipes 111.

This method requires a more specific manufacturing process for
the use described, but has the advantage of reducing the height of the
the whole while promoting heat exchange between pulsed heat pipes and cold plates.

This design also makes replacement easier in the event of a breakdown, as the assembly can be removed and replaced in a single operation.

FIG. 20 is an exploded perspective view of the cold plate and pulsed heat pipe assembly according to the embodiment of the present disclosure with two cold plates 622-726 and a double cold plate 621-625.

This view shows the head-to-tail arrangement of a type A pulsed heat pipe 623 and a type B pulsed heat pipe 624, as well as the possibility of juxtaposing several (here two) pulsed heat pipes 623-624 in parallel to thermally regulate a set of cells 101.

This FIG. 20 also illustrates the two heat transfer fluid circuits 625c-625d and 124a-124b for heat removal, on the one hand from the cold plate 625 intended to be in heat exchange capacity with the condensation part of the gravity heat pipes 111 and, on the other hand, from all three cold plates 621-622-726 intended to be in heat exchange capacity with the condensation part of the gravity heat pipes 111. in heat exchange capacity with the condensing part of the pulsed heat pipes 623-624 located, respectively, in the second wings 623b and 624b.

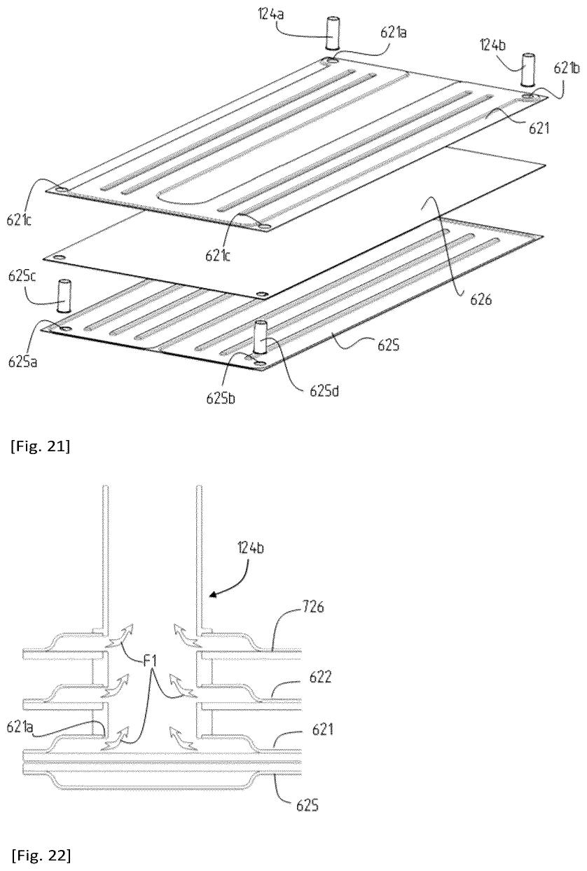

FIG. 21 is an exploded view of the double cold plate 621-625 and illustrates the possibility of interposing a layer 626 of thermal interface material (TIM) between said cold plates.

Such a material is well known for improving thermal coupling between two components, by limiting the thermal resistance that hinders heat dissipation at the interface of the two components.

Although not shown here to make the figures more detailed, it is possible to provide a layer of such a material thermal interface between the gravity and pulsed heat pipes and the cold plate(s) with which they are in contact, to improve heat transfer from the condensation part of the heat pipes to the cold plate in thermal contact with it.

FIG. 21 also partially illustrates the two separate heat transfer fluid circuits for heat removal from the double cold plate 621-625.

Thus, the cold plate 625, intended to be in contact with the condensation part of the second wing 111b of the gravity heat pipe(s) 111, has a cold heat transfer fluid inlet 625a and a hot heat transfer fluid outlet 625b, both extended by a fluid circulation tube, 625c and 625d respectively.

Similarly, the cold plate 621, intended to be in contact with the condensation part of the second wing 623b of the pulsed heat pipe(s) 623, has a cold heat transfer fluid inlet 621a and a hot heat transfer fluid outlet 621b, both extended by a fluid circulation tube 124a and 124b respectively.

The two tubes 625c and 625d pass through two sealed holes 621c located in the upper cold plate 621, without fluid communication with said upper cold plate 621. These holes 621 are simply there to allow the passage of tubes 625c and 625d and to limit the overall dimensions of the cold plate. the assembly. In other words, the heat transfer fluid circuit entering and leaving the cold plate 625 does not mix with the heat transfer fluid circuit entering and leaving the upper cold plate 621, which are therefore independent.

For the heat transfer fluid circuit in cold plates 621-622-726, on the other hand, tubes 124a and 124b pass through holes communicating with the inside of cold plates 622 and 726.

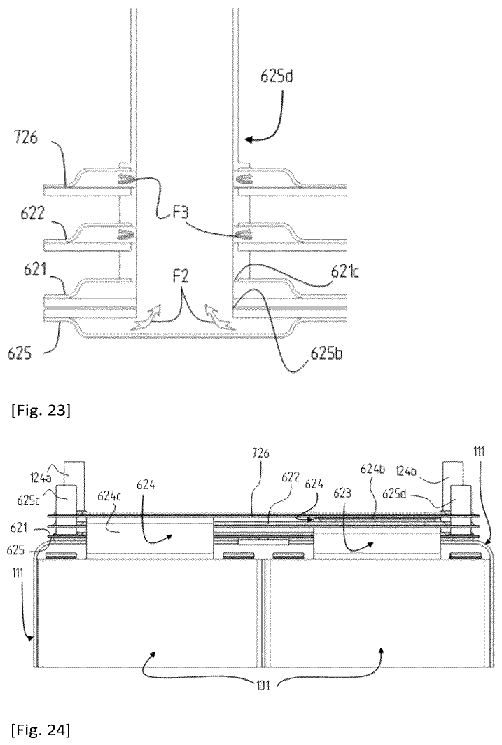

FIGS. 22 and 23 are cross-sectional views of a heat transfer fluid circuit outlet, respectively away from cold plates 621-622-726 in contact with pulsed heat pipes 623-624 and away from cold plate 621 in contact with gravity heat pipe(s) 111.

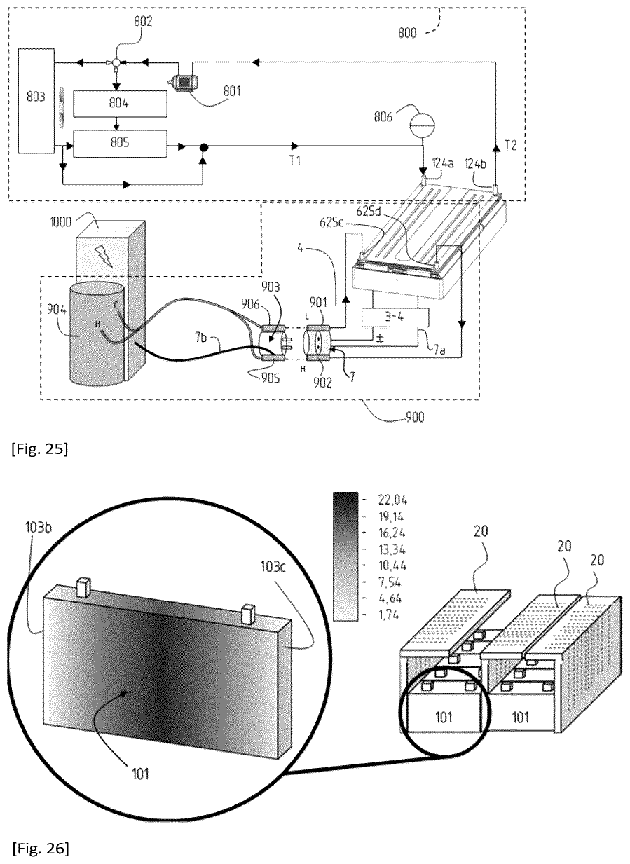

FIG. 22 shows the fluid communication between cold plates 621, 622 and 726 in tube 625d. In this way, the heat transfer fluid present in these cold plates can flow (arrows F1) out of the cold plate channels in tube 625d into the rest of the heat exchanger circuit to dissipate heat from the heat transfer fluid into the environmental air (see FIG. 25).

On the contrary, as shown in FIG. 23, tube 625d communicating with outlet 625b of cold plate 625, does not communicate with the inside of cold plates 621, 622 and 726. The heat transfer fluid circulating in cold plate 625 can therefore exit in the direction of arrows F2, whereas the heat transfer fluid circulating in cold plates 621, 622 and 726 collides with tube 625d and remains in these cold plates (arrows F3).

It is therefore possible to obtain a thermally controlled device from space-saving, yet featuring two fluid circuits independent heat transfer media, one for the cold plate in contact with the 111 gravity heat pipe(s), the other for the set of cold plates in contact with the pulsed heat pipes, thus optimizing thermal control of the 101 cells.

FIG. 24 illustrates a second variant of the embodiment of the present disclosure, comprising frontally, on the right side of the figure, a type A pulsed heat pipe 623, the condensing portion of which is inserted between the double cold plate and the intermediate cold plate, and, on the left side of the figure, a type B pulsed heat pipe 624, the condensing portion of which is inserted between the intermediate cold plate and the terminal cold plate.

At the rear, the device comprises two heat pipes similar to the first, but arranged in opposition: facing the pulsed heat pipe 623 type A, the second wing 624b of a type B heat pipe 624 can be seen, and opposite the type B pulsed heat pipe 623 on the left is a type A pulsed heat pipe 623 hidden by the pulsed heat pipe 624c core.

Finally, FIG. 25 illustrates a thermally controlled device according to the present disclosure, whose cold plates 621, 622 and 726 are connected to an operational heat transfer fluid circuit 800, including a radiator for removing heat from the heat transfer fluid to the ambient air.

In an operation designed to reduce cell temperature, the heat transfer fluid enters the cold plates 621, 622 and 726 through tube 124a at a temperature T1 sufficient to generate condensation in the second fins 623b and 624b of the pulsed heat pipes 623 and 624 and recover heat from these pulsed heat pipes. The heat transfer fluid then exits the cold plates 621, 622 and 726 through tube 124b at a temperature T2 higher than temperature T1.

This fluid circulation is created by a pump 801, which pumps the heat transfer fluid to a three-way valve 802.

This three-way valve 802 is connected to output 124b of the device according to the present disclosure, to a radiator 803 for cooling the heat transfer fluid, and to a heater 804. The three-way valve 802 can be controlled by the vehicle's on-board electronic system to selectively direct the heat transfer fluid to the radiator 803 to cool it or to the heater 804 to heat it, as required.

In fact, the optimum temperature range for battery operation and recharging is between 5 and 25 degrees Celsius.

During charging, batteries tend to heat up strongly and it is necessary to cool the battery cells to avoid any damage. and fire. This can also be the case during operation: pump 801 and three-way valve 802 are then controlled in response to a signal transmitted by a temperature sensor in the battery.

The cooled fluid having circulated in radiator 803 can then return directly to inlet 124a of the thermally controlled device according to the present disclosure, or pass through a heat exchanger 805 of an auxiliary thermal circuit in order to manage the calories in the vehicle more globally and using the thermal behavior of the thermally controlled device. according to the present disclosure.

Alternatively, in certain weather conditions or, more frequently, when the vehicle is being recharged “cold” i.e. when the batteries are at a temperature below 5° C., it may be useful to preheat the battery cells, which charge or operate more efficiently when they are at a temperature above 5° C. The three-way valve is then controlled to direct the fluid to the 804 heater. The heated fluid then returns to inlet 124a to reheat the cells. Once the optimum operating temperature has been reached, the three-way valve is controlled to direct the heat transfer fluid to the 803 radiator to limit the temperature rise of the battery for the remainder of the operation (use or charge).

The heat transfer fluid therefore enters the device according to the present disclosure with a different temperature T2 (higher or lower depending on the situation) than the temperature T1 at which the fluid leaves the device.

The fluid circuit naturally includes an expansion vessel 806 to absorb heat transfer fluid volume variations generated by temperature changes.

As explained above, when the device according to the present disclosure comprises a double cold plate (see FIGS. 9 to 12, and 14 to 24) between the gravity heat pipe(s) and the pulsed heat pipe(s), the system according to the present disclosure has two separate cooling circuits: a first 800 for the pulsed heat pipe(s) and a second 900 for the gravity heat pipe(s).

This arrangement is effective in terms of of calories out of the battery, and especially out of the vehicle.

Indeed, although not illustrated in FIG. 25, the 625c inlet and 625d outlet of the 625 cold plate in heat exchange capacity with the gravity heat pipe(s) can also be connected to the 801 pump, 803 radiator and 804 heater to improve thermal control of the battery cells during vehicle use.

As shown in FIG. 25, the 625c inlet and 625d outlet of the 625 cold plate can also be connected to a second 900 heat transfer fluid circuit connected to the vehicle's specially adapted 7 recharging socket. This charging socket 7 thus comprises:
an electrical circuit 7a connected to the battery for recharging it from an electrical source 1000 external to the vehicle (the circuit 7a is illustrated schematically; it naturally includes the other electrical or electronic components of the vehicle, such as the ECU 3 and the AC/DC charger/converter 4, whether the latter is independent or integrated directly into the battery modules);
an inlet 901 and an outlet 902 fluidically connected respectively to the inlet 625c and outlet 625d of the cold plate 625.

The heat transfer fluid circuit 900 also comprises a connector 903 complementary to the vehicle connector 7, the complementary connector 903 being electrically connected to a source 1000 of electrical energy (AC or DC) and fluidically connected to a source 904 of cold fluid, external to the vehicle.

For this purpose, the complementary socket 903 includes:
an electrical circuit 7b connected to the power source 1000 electric;
an inlet 905 and an outlet 906 fluidly connected to the external cold fluid source 904.

The cold liquid source 904 can, when the sockets 7 and 903 are connected, inject a very cold liquid into the cold plate, i.e. at a much colder temperature than that which can be obtained with the 803 radiator of the first circuit.

In fact, such a radiator can generally extract a maximum of 12 kilowatts (kW), whereas the target is to extract 20 to 25 kW during charging.

By connecting the second circuit to a source of cold fluid 904, for example at 5 degrees Celsius, it is perfectly possible to extract these 25 kW from the battery and from the vehicle.

It is therefore possible to obtain heat transfer fluid circuits at different cold temperatures, without mixing, when the vehicle is under load.

It is, of course, possible to reverse the circuit connections, with the inlet 124a and outlet 124b of the cold plates 621, 622 and 726 in heat exchange capacity with the pulsed heat pipes. connected to the 900 cold fluid circuit external to the vehicle, and that the 625c inlet and 625d outlet of the 625 cold plate in heat exchange capacity with the gravity heat pipes are connected to the 800 heat transfer fluid circuit internal to the vehicle.

FIG. 26 illustrates the temperature gradient within a 101 cell when the latter is only capable of heat exchange with 20 gravity heat pipes. The gradient shown is the temperature difference between the coldest and hottest points of the cell.

On the one hand, the gradient is regular across the cell: the center of cell 101 is warm over the entire height of the cell, and the areas along the second 103b and third 103c sides of the cell are cool over the entire height. In addition, the temperature gradient between the edges and the center is also significant: around 22 to 23 degrees Celsius. With regard to thermal stress ii) the amplitude of the temperature gradient within the plant. of the cell is essential.

FIG. 27 illustrates the temperature gradient within a cell 101 when the latter is in heat exchange capacity with gravity heat pipes 20 and pulsed heat pipes 30 (symbolized in gray on the figure) above the first side 103a and below the fourth side 103d of the cell.

The temperature gradient is not uniform across the cell. Only the heart of the cell has the warmest temperature. The second, third and fourth sides are the coldest. The center of the first side is also a cool zone, thanks to the pulsed heat pipe arranged between the terminals above the first side of the cell.

The temperature gradient between the coldest and warmest areas does not exceed 5 to 6 degrees Celsius.

The areas below the cell terminals are also hot, but a little less so than the core: if the pulsed heat pipes do not cover the terminals, the areas below them nevertheless benefit from a small amount of calorie absorption by the pulsed heat pipes.

This shows that the gradient amplitude is reduced (approx. 5 to 6 degrees Celsius) compared to the gradient amplitude obtained with the device shown in FIG. 26 (approx. 22 to 23 degrees Celsius).

Pulsed heat pipes don't just cool the first and fourth sides in the same way as gravity heat pipes, because if they didn't only the cell core would be hot, but the gradient would be similar to that shown in FIG. 26.

Their arrangement ensures a synergistic effect, not only cooling the cell from the first side and possibly the fourth side, but also promoting condensation within the heat pipes. which improves their efficiency. The result is not only better cell cooling, but also a lower thermal amplitude within the cells, thus satisfying thermal constraints i) and ii).

In addition, the fact that gravity heat pipes and pulsed heat pipes all extend along the modules, this ensures thermal control of the entire module and meets the thermal constraint iii) by preventing the central cells within the module from reaching the maximum operating temperature (45 degrees Celsius).

1. A thermally controlled device for storing electrical energy in chemical form for a vehicle, the controlled device comprising:
a plurality of electrical cells;
a first heat exchange device comprising a bent gravity heat pipe, having an evaporation portion in heat exchange capacity with one side of the cells and a condensation portion in heat exchange capacity with a cold source of a second heat exchange device, the cold source comprising at least
two cold plates;
the second heat exchanger comprising at least one pulsed heat pipe featuring:
a first wing extending under the condensation part of the gravity heat pipe and in heat exchange capacity with part of the cell edge;
a second wing extending in heat-exchange capacity with at least one of the cold plates; and
a web connecting the wings.

2. The thermally controlled device according to claim 1, comprising an electric battery having a plurality of electric cells each presenting two faces joined by an edge, where the cell is thinnest and where at least a first side, a second side and a third side are located, the second side and third side being parallel to each other and transverse to the first side, each cell comprising a cathode terminal and an anode terminal located on a single side or on two different sides of the wafer, the terminals of adjacent cells being connected to each other to form the battery, the cells being arranged parallel to each other, along a longitudinal direction (L-L), face to face, wherein:
the gravity heat pipe of the first heat exchange device is capable of heat exchange with at least the second side or the third side of the cells and the cold source of at least one second heat exchange device,
the gravity heat pipe comprises a body internally integrating a series of juxtaposed channels containing a heat-carrying substance and two transverse volumes into which the ends of the channels open so that they communicate fluidically with each other via these transverse volumes;
the body of the gravity heat pipe is bent, L-shaped or C-shaped, so that the channels each have at least one curved part located between two wings, a first wing carrying at least one vaporizing portion (PV) and a second wing carrying a condensing portion (PC), the condensing portion being located at a higher elevation than the vaporizing portion relative to gravity in the position of use;
the gravitational heat pipe is arranged so that the first wing carrying the vaporization portion (PV) extending laterally opposite the second side or the third side of the edge of the cells at a first distance (d1), while the second wing of the gravitational heat pipe carrying the condensation portion (PC) extending laterally above the first side of the edge of the cells at a second distance (d2), at a second distance (d2) strictly greater than the first distance (d1);
the second heat exchanger includes:
the cold source which comprises at least a first cold plate and a second cold plate in which a heat transfer fluid circulates between an inlet and an outlet, the first and second cold plates extending parallel to each other, longitudinally, flat and facing the first side of the cells;
at least one pulsed heat pipe comprising a body internally integrating at least one channel closed on itself to form a loop and incorporating a heat-carrying substance, the channel having convolutions and extending between an evaporation portion in thermal contact with at least part of the first side of the edge of the cells, and a second condensation portion in thermal contact with a face of each of the first and second cold plates, the body of the pulsed heat pipe being C-bent to present:
the first wing extending longitudinally between the first side of the cell edge and the condensation part of the gravity heat pipe(s), and comprising the evaporation part in heat exchange capacity with at least part of the first side of the cell edge, the second wing parallel to the first wing and comprising the condensation portion extending in heat exchange capacity with at least one of the first and second cold plates;
core connecting the first and second wings.

3. Thethermally controlled device according to claim 1, wherein the second wing of said at least one pulsed heat pipe extends between two of said at least two cold plates and is capable of heat exchange with two of said at least two cold plates.

4. The thermally controlled device according to claim 1, comprising, at least one first pulsed heat pipe and at least one second pulsed heat pipe and wherein:
the first wing of the first pulsed heat pipe extends longitudinally between the first side of the cell slice and the condensation part of the gravity heat pipe(s), and in heat exchange capacity with a first half-length (D/2) of the first side of the cell slice, and the second wing of the first pulsed heat pipe extends between, and in heat exchange capacity with, the first and second cold plates; and
the first wing of the second pulsed heat pipe extends longitudinally between the first side of the cell edge and the condensation part of the gravity heat pipe(s), and in heat exchange capacity with a second half-length (D/2) of the first side of the cell edge, and the second leg of the second pulsed heat pipe extends in heat-exchange capacity with a free face of the second cold plate.

5. The thermally controlled device according to claim 1, comprising, at least one first pulsed heat pipe and at least one second pulsed heat pipe and wherein:
the first wing of the first pulsed heat pipe extends longitudinally between the first side of the cell slice and the condensation portion of the gravity heat pipe(s), and is in heat-exchange relationship with a length (D) of the first side of the cell slice, and the second legof the first pulsed heat pipe extends between, and is in heat-exchange relationship with, the first and second cold plates; and
the first leg of the second pulsed heat pipe extends longitudinally under the fourth side of the cell slice, and is in heat-exchange relationship with a length (D) of the fourth side of the cell slice, and the second leg of the second pulsed heat pipe extends in heat-exchange relationship with at least one free face of the second cold plate.

6. The thermally controlled device according to claim 5, wherein the cold source of the second The heat exchange device comprises at least a third cold plate.

7. The thermally controlled device according to claim 6, wherein the third cold plate is arranged parallel to and opposite the second cold plate, in heat exchange capacity with the second leg of the second pulsed heat pipe.

8. The thermally controlled device according to claim 6, wherein the third cold plate is arranged against the first cold plate, able to of heat exchange with said at least one gravity heat pipe, the first and second cold plates being connected to a first heat transfer fluid circuit and the third cold plate being connected to a second heat transfer fluid circuit independent of the first heat transfer fluid circuit.

9. The thermally controlled device of claim 8, wherein the cold source of the second heat exchange device comprises a fourth cold plate arranged parallel and opposite the second cold plate, in heat exchange capacity with a free face of the second flange of the second pulsed heat pipe.

10. The thermally controlled device of claim 2, wherein the pulsed heat pipe(s) is/are in thermal contact against the first side and/or the fourth side of the cell or terminals carried by said first side, a layer of electrically insulating material being interposed between the pulsed heat pipe(s) and the first side of the cell or terminals carried by said first side.

11. The thermally controlled device according to claim 10, wherein the cold plates and pulsed heat pipe(s) are in a single block within which the cold plates and pulsed heat pipe(s) are functionally separated from each other by a single wall.

12. The thermally controlled device according to claim 2, further comprising a housing in which the plurality of cells are arranged, the housing comprising:
a bottom on which the cells and a plurality of gravity heat pipes rest, and
clamping means configured to clamp each heat pipe against the second side and/or third side of the opposing cell(s), so that the or each vaporizing portion of the heat pipe(s) is pressed against the opposing cell(s).

13. The thermally controlled device according to claim 12, in which the clamping means comprise upright walls, bearing against the bottom and surrounding the cells and the plurality of said gravity heat pipes, as a whole.

14. The thermally controlled device according to claim 11, wherein the cold plate which covers the second flange of the second pulsed heat pipe, is fixed to the housing so that all the cells and all the gravity heat pipes and pulsed heat pipes as a whole are clamped between the housing and the cold plate covering the second flange of the second pulsed heat pipe.

15. Electric or hybrid vehicle comprising:
at least one electric motor to move it, and
at least one thermally controlled device according to claim 1, connected to the electric motor to supply it with electricity;
at least one electrical outlet connected to said at least one thermally controlled device to charge it with electricity.
